(19) United States
(12) Patent Application Publication
(10) Pub. No.: US 2014/0073255 A1
(43) Pub. Date: Mar. 13, 2014

(54) SYSTEM AND METHOD FOR INTERACTING WITH CONTENT OF AN ELECTRONIC DEVICE

(71) Applicants: Alexander Friedrich KUSCHER, San Francisco, CA (US); Trond Thomas WUELLNER, Mountain View, CA (US); Hristo Stefanov STEFANOV, Mountain View, CA (US)

(72) Inventors: Alexander Friedrich KUSCHER, San Francisco, CA (US); Trond Thomas WUELLNER, Mountain View, CA (US); Hristo Stefanov STEFANOV, Mountain View, CA (US)

(73) Assignee: Google Inc., Mountain View, CA (US)

(21) Appl. No.: 13/607,579

(22) Filed: Sep. 7, 2012

(51) Int. Cl. H04B 7/00

(52) U.S. Cl. 455/41.3

(57) ABSTRACT

A system and method for interacting with content of an electronic device are provided. A second electronic device is detected to be within proximity of a first electronic device. Communication with the second electronic device is established in response to the detected proximity. Data is received from the second electronic device. The received data is provided for display on a display screen of the first electronic device in response to receiving the data from the second electronic device. One or more input devices communicatively connected to the first electronic device are used to modify the data. The modified data is provided to the second electronic device.

### FIELD

The subject technology generally relates to interacting with electronic content, and in particular, relates to interacting with content of an electronic device.

### BACKGROUND

Mobile electronic devices often sacrifice size to gain greater mobility. While greater mobility allows a user to access information provided by a mobile electronic device in more geographical locations, the user may find it difficult to view the provided information on the mobile electronic device due to its display screen size. Furthermore, the user may also find it difficult to interact with the provided information.

### SUMMARY

The disclosed subject technology relates to a computer-implemented method for interacting with content of an electronic device. The method comprises detecting proximity of a second electronic device with respect to a first electronic device. The method further comprises establishing communication with the second electronic device in response to the detected proximity. The method further comprises receiving data from the second electronic device. The method further comprises providing, in response to receiving the data from the second electronic device, the received data for display on a display screen of the first electronic device. The method further comprises modifying the data using one or more input devices communicatively connected to the first electronic device. The method further comprises providing the modified data to the second electronic device.

The disclosed subject matter further relates to a system for interacting with content of an electronic device. The system comprises one or more processors, and a machine-readable medium comprising instructions stored therein, which when executed by the processors, cause the processors to perform operations comprising identifying a type of radio data communication service that is supported by a first electronic device and a second electronic device. The operations further comprise obtaining a unique identifier of the second electronic device. The operations further comprise detecting proximity of a second electronic device with respect to a first electronic device, wherein the detecting comprises scanning for the obtained unique identifier of the second electronic device, and detecting the unique identifier based on the scan. The operations further comprise establishing communication with the second electronic device in response to the detected proximity. The operations further comprise receiving data from the second electronic device. The operations further comprise providing, in response to receiving the data from the second electronic device, the received data for display on a display screen of the first electronic device. The operations further comprise modifying the data using one or more input devices communicatively connected to the first electronic device. The operations further comprise providing the modified data to the second electronic device.

The disclosed subject matter further relates to a machine readable medium comprising instructions stored therein, which when executed by a processor, cause the processor to perform operations comprising identifying a type of radio data communication service that is supported by a laptop and a smartphone device. The operations further comprise obtaining a unique identifier of the smartphone device. The operations further comprise detecting the proximity of the smartphone device with respect to the laptop, wherein the detecting comprises scanning for the obtained unique identifier of the smartphone device, and detecting the unique identifier based on the scan. The operations further comprise establishing communication with the smartphone device in response to the detected proximity. The operations further comprise receiving data from the smartphone device. The operations further comprise providing, in response to receiving the data from the second electronic device, the received data for display on a display screen of the first electronic device. The operations further comprise modifying the data using one or more input devices communicatively connected to the laptop. The operations further comprise providing the modified data to the smartphone device.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment for interacting with content of an electronic device.

FIG. 2 illustrates an example process for interacting with content of an electronic device.

FIG. 3 is an example illustration for interacting with content stored on a second electronic device where the second electronic device is within proximity of a first electronic device.

FIG. 4 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology may run on any electronic device capable of transmitting data and/or receiving data. The subject technology may run on multiple electronic devices (e.g., smartphones, laptop computers, tablet computers, PDAs, desktop computers, etc.) and may allow the multiple electronic devices to communicate with each other.

The subject technology may initiate a “handshake” mode between a first electronic device (e.g., a laptop computer) and a second electronic device (e.g., a smartphone device). The initiation of a “handshake” mode commences preparation to establish communication between the first electronic device and the second electronic device. During the “handshake” mode, the subject technology may identify one or more types of radio data communication services that are supported by both the first and second electronic devices. Example types of radio data communication service include, but are not limited to, WiFi, Bluetooth, Near Field Communication, WiMAX, etc. The “handshake” mode may also designate one or more types of radio data communication services for communication between the first electronic device and the second electronic device. One or more unique identifiers of the first and second electronic devices (e.g., their respective media access control addresses) may be obtained to identify the first and second electronic devices.

Upon initiation of the “handshake” mode, the subject technology may detect proximity of the second electronic device (e.g., smartphone) with respect to the first electronic device (e.g., laptop). One example method for detecting the proximity of the second electronic device is to scan for a media access control address that is assigned to the second electronic device. If the second electronic device is detected, a connection is established between the first electronic device and the second electronic device via a designated radio data communication service.

Data stored on the second electronic device is sent to the first electronic device after communication between the first electronic device and the second electronic device has been established. The second electronic device may maintain a copy of the data sent to the first electronic device while the data is being modified by the first electronic device. The data may include a content item (e.g., a document, an image file, etc.). The data may also include a metadata. Furthermore, the data may also include a data structure (e.g., a tree) of one or more data nodes. The data structure may be a grouping of individual content items, where each of the individual content items corresponds to an individual node. In one example, a data structure may be a grouping of image files, where each image file of the group of image files corresponds to a node within the data structure for the grouping of image files.

Upon receipt of the data, the received data may be provided for display on a display screen that is associated with the first electronic device. Where the first electronic device is a laptop computer or a desktop computer and the second electronic device is a smartphone device, the provided image that is displayed on the display screen of the first electronic device may have a physical dimension that is several magnitudes larger than the size of the display screen of the second electronic device. Furthermore, the provided data may also be modified using one or more input devices that are communicatively connected to the first electronic device. The one or more input devices may include keyboard, mouse, touchscreen, etc. This allows modifications to the received data to be made while the received data is displayed on the first electronic device's display screen.

Where the provided data is an image file, modification of the provided image file may include utilizing a mouse that is communicatively connected to the first electronic device to crop the image file. Where the provided data is a document, modification of the provided file may include utilizing a keyboard that is communicatively connected to the first electronic device to edit of the document's content. Where the provided data is a data structure of a group of content items, a particular content item within the group of content items may be modified. For example, where the provided data is a group of pictures, and each picture of the group of pictures is associated with a unique metadata, a modification may include using a keyboard to modify a metadata for a particular picture of the group of pictures. Alternatively, where the provided data is a data structure of a group of data nodes, a modification may cause multiple data nodes of the data structure, or all of the data nodes of the data structure to be modified collectively.

The modified data is then provided to the second electronic device. In one example, a copy of the modified data is provided by the first electronic device to the second electronic device after the modification has been made. The first electronic device may also send an instruction to the second electronic device to swap out a stored copy of the data with the modified data transmitted from the first electronic device. Where the data is a data structure with one or more data nodes, and a modification is made with respect to a data node of the one or more data nodes of the data structure, the entire structure may be provided to the second electronic device. Alternatively, data corresponding to the modified data node may be provided to the second electronic device.

If the second electronic device has maintained a unmodified copy of data sent to the first electronic device, the second electronic device replaces the unmodified copy of the data with the modified copy provided by the first electronic device. In one example, if the second electronic device has maintained a copy of an image file that it sent to the first electronic device for modification, the second electronic device may swap the unmodified copy of the image file with a modified copy of the image file upon receipt of the modified copy of the image file from the first electronic device. In another example, if the second electronic device has maintained a copy of a data structure that it transmitted to the first electronic device for modification, the second electronic device may swap the unmodified copy of the data structure with the modified copy of the data structure.

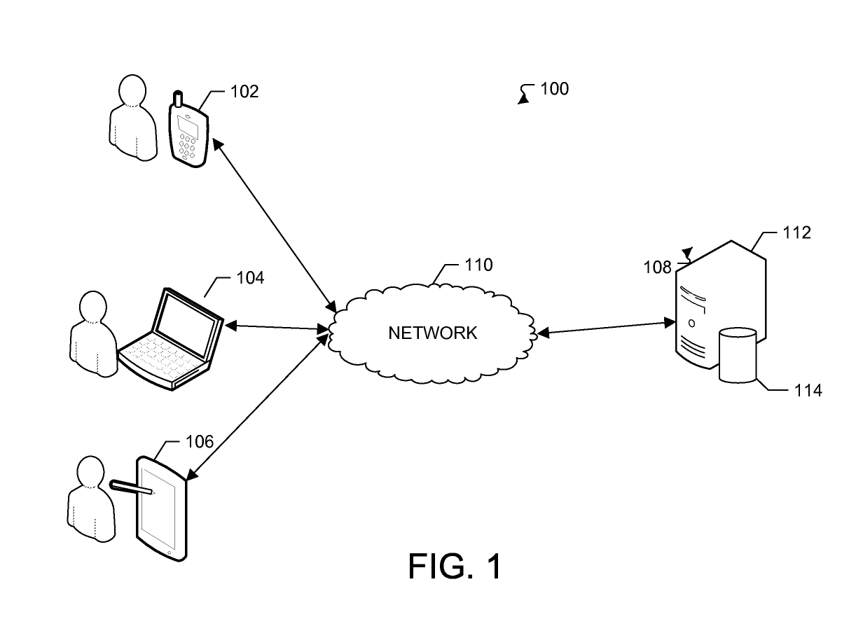

FIG. 1 illustrates an example distributed network environment for interacting with content of an electronic device. A network environment 100 includes a number of electronic devices 102, 104, and 106 communicatively connected to a server 108 by a network 110. Server 108 includes a processing device 112 and a data store 114. Processing device 112 executes computer instructions stored in data store 114, for example, to provide data to electronic device 102, 104, or 106.

In some example aspects, each of the electronic devices 102, 104, or 106 may include any machine with hardware and software to support one or more radio data communication services. Electronic devices 102, 104, and 106 can be mobile devices (e.g., smartphones, tablet computers, PDAs, and laptop computers), portable media players, desktop computers or other appropriate computing devices. In the example of FIG. 1, electronic device 102 is depicted as a smartphone, electronic device 104 is depicted as a laptop computer, and electronic device 106 is depicted as a tablet computer.

In some example aspects, a first electronic device 102, 104, or 106 detects proximity of a second electronic device 102, 104, or 106 with respect to the first electronic device. For example, the first electronic device 102, 104, or 106 may detect proximity of the second electronic device 102, 104, or 106 by scanning for a media access control address corresponding to the second electronic device. The first electronic device 102, 104, or 106 establishes communication with the second electronic device 102, 104, or 106 in response to the detected proximity.

Upon establishing communication, the first electronic device 102, 104, or 106 receives data that is stored on the second electronic device 102, 104, or 106. A copy of the received data may also be stored on server 108, and may be transmitted to the second electronic device 102, 104 or 106. In one example, the received data is metadata. In another example, the received data is content data (e.g., an image file, a document, etc.) stored on the second electronic device 102, 104, or 106. In another example, the received data is a data structure that contains one or more data nodes.

The first electronic device 102, 104, or 106 provides the received data for display on a display screen of the first electronic device in response to receiving the data from the second electronic device 102, 104, or 106. Where the received data is an image file, the image file may be provided for display on the display screen of the first electronic device 102, 104, or 106. Where the received data is a document, the document may be provided for display on the display screen of the first electronic device 102, 104, or 106.

The received data may be modified using one or more input devices communicatively connected to the first electronic device. Where the received data is an image file, the image file may be modified using the one or more input devices communicatively connected to the first electronic device. Where the received data is a document, the document may be modified using the one or more input devices communicatively connected to the first electronic device. Where the received data is a data structure having one or more data nodes, one of the one or more data nodes of the data structure may be modified.

The first electronic device 102, 104, or 106 provides the modified data to the second electronic device 102, 104, or 106. Where the received data is a data structure having one or more data nodes, and one of the one or more data nodes have been modified, the entire data structure containing the modified data node may be provided to the second electronic device 102, 104, or 106. Alternatively, only the modified data node may be provided to the second electronic device 102, 104, or 106.

Server 108 may be any system or device having a processor, memory, and communications capability for providing data to electronic device 102, 104, or 106. Server 108 may be a single computing device such as a computer server. Furthermore, server 108 may also represent more than one computing device working together to perform the actions of a server computer.

Server 108 includes a processing device 112 and a data store 114. Processing device 112 executes computer instructions stored in a computer-readable medium, for example, provide web data to electronic device 102, 104, or 106. Data store 114, contains the provided web data as well as other types of data which may be transmitted to the electronic device 102, 104, or 106.

Network 110 can include, for example, any one or more of a cellular network, a satellite network, a personal area network (PAN), a local area network (LAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

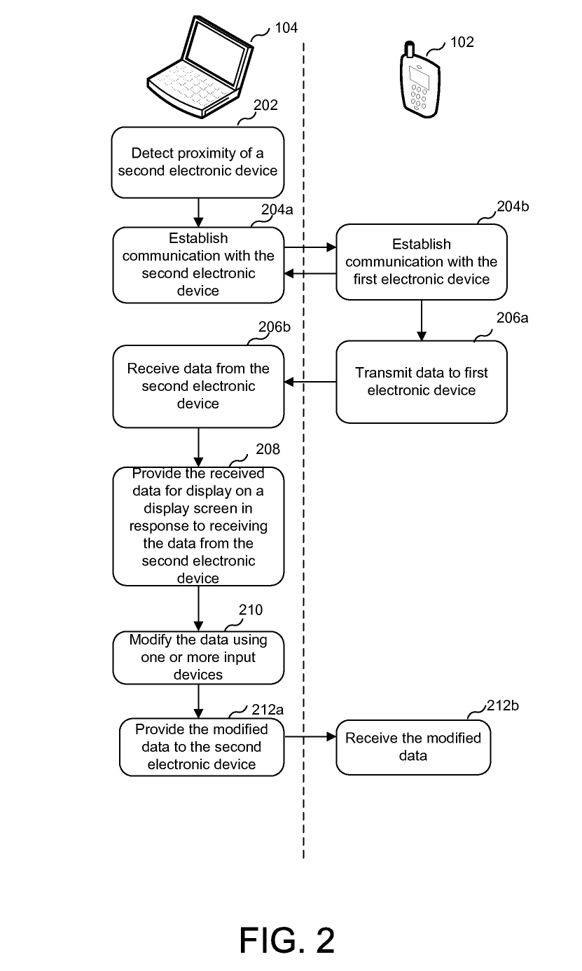

FIG. 2 illustrates an example process for interacting with content of an electronic device. A first electronic device 104 and a second electronic device 102 are depicted in FIG. 2 as a laptop computer and a smartphone device respectively. The first electronic device 104 and the second electronic device 102 may be any electronic device having hardware and software to support one or more radio data communication services (e.g., WiFi, Bluetooth, etc.). For example, the first electronic device and second electronic device may be a laptop computer 104 and a smartphone device 102, respectively. Additional examples of the first electronic device and/or the second electronic device include desktops, tablet computers, PDAs, etc.

The first electronic device 104 enters into a handshake mode with the second electronic device 102, during which, the first electronic device 104 identifies one or more types of radio data communication services that are supported by both the first electronic device 104 and the second electronic device 102. The first electronic device 104 may obtain one or more identifiers of the second electronic device 102. The identifier may be a media access control address, radio-frequency identification, etc. The first electronic device 104 may also provide the second electronic device 102 with one or more identifiers of the first electronic device 104. The first electronic device 104 may designate one of the one or more types of radio data communication services that is supported by both the first electronic device 104 and the second electronic device 102 as the default transport protocol for communication between the first electronic device 104 and the second electronic device 102. One or more applications running on the first electronic device 104 may initiate the handshake mode. The one or more applications may also be running on the second electronic device 102 to facilitate the handshake mode.

The first electronic device 104 detects proximity of the second electronic device 102 in step 202. In one example, the first electronic device 104 can scan for an identifier of the second electronic device 102 (e.g., a media access control address of the second electronic device) and detect the unique identifier based on the scan. The first electronic device 104 would determine that the second electronic device 102 is within proximity of the first electronic device 104 if it finds the identifier of the second electronic device 102.

In steps 204a and 204b, the first electronic device 104 and the second electronic device 102 establish communication with each other. Communication may be directly established between the first electronic device 104 and the second electronic device 102 (e.g., via. Bluetooth). A networking device (e.g., a router, an access point, etc.) may also be used to facilitate communication between the first electronic device 104 and the second electronic device 102.

In step 206a, the second electronic device 102 transmits data to the first electronic device 104. The transmitted data may include different types of mutable data that is stored on the second electronic device 102. In one example, the received data is metadata. In another example, the received data is a data structure (e.g., a tree) having one or more data nodes. In a further example, the received data is a content data (e.g., an image file, a document, etc.). In step 206b, the first electronic device 104 receives data from the second electronic device 102. Data may be transferred directly between the second electronic device 102 and the first electronic device 104. One or more network devices (e.g., a router, an access point, etc.) may facilitate data transfer between the second electronic device 102 and the first electronic device 104.

In step 208, the first electronic device 104 provides the received data for display on a display screen in response to receiving the data from the second electronic device 102. The data may be automatically provided for display on the display screen of the first electronic device 104 in response to receiving the data from the second electronic device 102. Alternatively, the data may be provided for display in response to a user action (e.g., a user request to access the data). One or more applications running on the first electronic device 104 may be used to provide an interface for displaying the received data. For example, if the data is an image file, one or more applications that support the image file may provide an interface for displaying the image file on the display screen of the first electronic device 104. In another example, if the received data is a document, one or more applications that support the document may provide an interface for displaying the document on the first electronic device 104. If the received data is a data structure for a grouping of image files, the grouping of the image files may be provided for display on the display screen of the first electronic device 104. For example, if the received data structure is a grouping of image files that are further sub grouped by year of creation, one or more individual image files belonging to the grouping of image files may be separately displayed on the display screen of the first electronic device 104. Alternatively, the entire grouping of image files may be displayed on the display screen of the first electronic device. 104. In one example, a user interface (e.g., a folder) containing a list of each of the image files of the grouping of image files may be provided for display on the display screen of the first electronic device 104.

In step 210, the first electronic device 102 modifies the received data using one or more input devices. Example input devices include mouse, keyboard, touchpad, etc. Where the received data is an image file, the image file may be modified using the one or more input devices communicatively connected to the first electronic device 104. Where the received data is a document, the document file may be modified using the one or more input devices communicatively connected to the first electronic device 104.

Where the received data is a data structure having one or more data nodes, one or more of the one or more data nodes of the data structure may be modified. Alternatively, the organization of the data structure may be modified. For example, if the received data structure is a grouping of music files that are further sub grouped by genre, one or more individual music files belonging to the grouping of music files may also be modified using the one or more input devices of the first electronic device 104. Example modifications include modifying the file type of the music file, size, name, any metadata associated with the music file, etc. Alternatively, a modification may be made to the organization of the grouping of music files. For example, sub groups may be regrouped by language.

In step 212a, the first electronic device provides the modified data to the second electronic device 102. Where the received data is a data structure having one or more data nodes, and one of the one or more data nodes have been modified, the entire data structure containing the modified data node may be provided to the second electronic device 102. For example, if the organization of the data structure has been modified, the entire data structure is provided to the second electronic device 102. Alternatively, if a modification is made to one of the one or more data nodes of the data structure, only the modified data node may be provided to the second electronic device 102. The second electronic device 102 receives the modified data in step 212b.

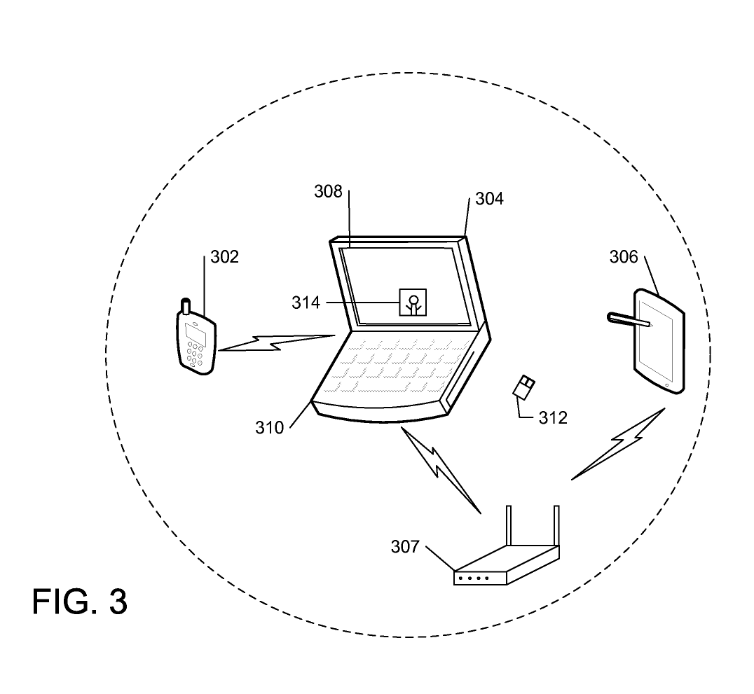

FIG. 3 is an example illustration for interacting with content stored on a second electronic device where the second electronic device is within proximity of a first electronic device. The dotted circle as shown in FIG. 3 represents proximity of the laptop device 304. The first electronic device is represented as a laptop computer 304, and the second electronic device is represented as a smartphone device 302, or a tablet device 306. The first electronic device 304 establishes communication with the second electronic device 302 or 306 once the second electronic device 302 or 306 is within proximity of the first electronic device 304. In one example, communication between the first electronic device 304 and the second electronic device 302 or 306 is automatically established in response to the first electronic device 304 detecting the proximity of the second electronic device 302 or 306. Communication between the first electronic device 304 and the second electronic device 302 may be direct (e.g., via Bluetooth). Alternatively, communication between the first electronic device 304 and the second electronic device 306 may be facilitated by another networking device 307 (e.g., a router, an access point, etc.).

Once communication between the first electronic device 304 and the second electronic device 302 or 306 has been established, the first electronic device 304 may receive data that is stored on the second electronic device 302 or 306. The received data may be displayed on the first electronic device's display screen 308. The received data as shown in FIG. 3 is an image file 314. One or more applications running on the first electronic device 304 may provide an interface for displaying the image file 314. Additional types of data (e.g., a document, metadata, data structure, etc.) may also be transmitted from the second electronic device 302 or 306 and may be received by the first electronic device 304.

The received image file 314 may be modified by one or more input devices that are communicatively connected to the first electronic device 304. One or more applications running on the first electronic device 304 can provide a platform for modifying the image file 314. In FIG. 3, input devices are depicted as keyboard 310 and mouse 312. In one example, keyboard 310 and mouse 312 may be used to crop the image file 314.

The modified image file is then provided by the first electronic device 304 to the second electronic device 302 or 306. Transfer of the modified image file transfer of the modified image file from the first electronic device 304 to the second electronic device 302 or 306 may be direct (e.g., via Bluetooth). Alternatively, transfer of the modified image file from the first electronic device 304 to the second electronic device 302 or 306 may be facilitated by another networking device 307 (e.g., a router, an access point, etc.).

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

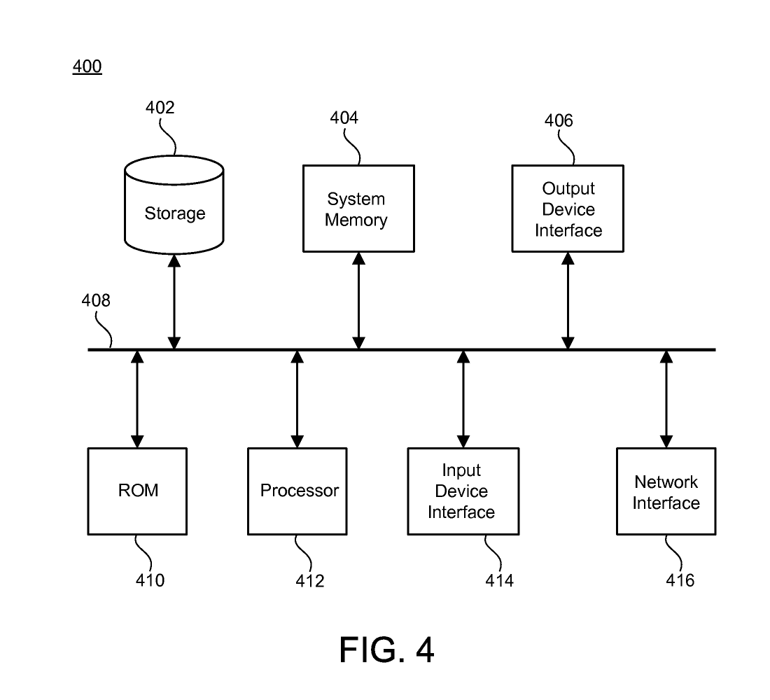

FIG. 4 conceptually illustrates an electronic system with which some implementations of the subject technology are implemented. Electronic system 400 can be a laptop computer, a desktop computer, smartphone, PDA, a tablet computer or any other sort of device 102, 104, and 106. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's electronic device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to an electronic device (e.g., for purposes of displaying data to and receiving user input from a user interacting with the electronic device). Data generated at the electronic device (e.g., a result of the user interaction) can be received from the electronic device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for interacting with content of an electronic device, the method comprising:
detecting proximity of a second electronic device with respect to a first electronic device;
establishing communication with the second electronic device in response to the detected proximity;
receiving data from the second electronic device;
providing, in response to receiving the data from the second electronic device, the received data for display on a display screen of the first electronic device;
modifying the data using one or more input devices communicatively connected to the first electronic device; and
providing the modified data to the second electronic device.

2. The computer-implemented method of claim 1, further comprising:
identifying a type of radio data communication service that is supported by both the first electronic device and the second electronic device;
obtaining a unique identifier of the second electronic device; and
wherein the detecting comprises scanning for the unique identifier of the second electronic device, and detecting the unique identifier based on the scan.

3. The computer-implemented method of claim 1, further comprising:
providing an application running on the first electronic device with access to the received data.

4. The computer-implemented method of claim 1, wherein the received data is metadata.

5. The computer-implemented method of claim 1, wherein the received data comprises content data that is stored on the second electronic device.

6. The computer-implemented method of claim 5, wherein the content data is an image file, and wherein the image file is provided for display on the display screen of the first electronic device, and wherein the modifying the image file comprises using the one or more input devices communicatively connected to the first electronic device to crop the image file.

7. The computer-implemented method of claim 5, wherein the content data is a document, and wherein the document is provided for display on the display screen of the first electronic device, and wherein the modifying the document comprises using the one or more input devices communicatively connected to the first electronic device to edit the document.

8. The computer-implemented method of claim 1, wherein the received data is a data structure comprising a plurality of data nodes, and wherein the modifying comprises modifying one of the plurality of data nodes, and wherein the providing the modified data comprises providing the modified data structure to the second electronic device.

9. The computer-implemented method of claim 1, wherein the received data is a data structure comprising a plurality of data nodes, and wherein the modifying comprises modifying one of the plurality of data nodes, and wherein the providing the modified data comprises providing the modified data node to the second electronic device.

10. The computer-implemented method of claim 1, wherein detecting the proximity of the second electronic device comprises scanning for a media access control address corresponding to the second electronic device.

11. The computer-implemented method of claim 1, wherein the first electronic device is a laptop and the second electronic device is a smartphone device.

12. The computer-implemented method of claim 1, wherein the first electronic device is a smartphone device and the second electronic device is a laptop computer.

13. A system for interacting with content of an electronic device, the system comprising:
one or more processors, and
a machine-readable medium comprising instructions stored therein, which when executed by the processors, cause the processors to perform operations comprising:
identifying a type of radio data communication service that is supported by a first electronic device and a second electronic device;
obtaining a unique identifier of the second electronic device;
detecting proximity of a second electronic device with respect to a first electronic device, wherein the detecting comprises scanning for the obtained unique identifier of the second electronic device, and detecting the unique identifier based on the scan;
establishing communication with the second electronic device in response to the detected proximity;
receiving data from the second electronic device;
providing, in response to receiving the data from the second electronic device, the received data for display on a display screen of the first electronic device;
modifying the data using one or more input devices communicatively connected to the first electronic device; and
providing the modified data to the second electronic device.

14. The system of claim 13, wherein the received data is metadata.

15. The system of claim 13, wherein the received data comprises content data that is stored on the second electronic device.

16. The system of claim 15, wherein the content data is an image file, and wherein the image file is provided for display on the display screen of the first electronic device, and wherein the modifying the image file comprises using the one or more input devices communicatively connected to the first electronic device to crop the image file.

17. The system of claim 15, wherein the content data is a document, and wherein the document is provided for display on the display screen of the first electronic device, and wherein the modifying the document comprises using the one or more input devices communicatively connected to the first electronic device to edit the document.

18. The system of claim 13, wherein the received data is a data structure comprising a plurality of data nodes, and wherein the modifying comprises modifying one of the plurality of data nodes, and wherein the providing the modified data comprises providing the modified data structure to the second electronic device.

19. The system of claim 13, wherein the received data is a data structure comprising a plurality of data nodes, and wherein the modifying comprises modifying one of the plurality of data nodes, and wherein the providing the modified data comprises providing the modified data node to the second electronic device.

20. A machine-readable medium comprising instructions stored therein, which when executed by a processor, cause the processor to perform operations comprising:
identifying a type of radio data communication service that is supported by a laptop and a smartphone device;
obtaining a unique identifier of the smartphone device;
detecting the proximity of the smartphone device with respect to the laptop, wherein the detecting comprises scanning for the obtained unique identifier of the smartphone device, and detecting the unique identifier based on the scan;
establishing communication with the smartphone device in response to the detected proximity;
receiving data from the smartphone device;
providing, in response to receiving the data from the second electronic device, the received data for display on a display screen of the first electronic device;
modifying the data using one or more input devices communicatively connected to the laptop; and
providing the modified data to the smartphone device.
